(19) United States
(12) Patent Application Publication
(10) Pub. No.: US 2010/0142501 A1
(43) Pub. Date: Jun. 10, 2010

(54) System and method for location services over wireless LANs

(75) Inventor: Simon Hochbaum, Sunnyvale, CA (US)

Correspondence Address: THE LAW OFFICES OF DENNIS L. COOK, PLLC, 10004 MARATHON COURT, TAMPA, FL, 33615, US

(73) Assignee: xG Technology, Inc., Sarasota, FL (US)

(21) Appl. No.: 12/590,934

(22) Filed: Nov. 17, 2009

Related U.S. Application Data
(60) Provisional application No. 61/199,477, filed on Nov. 17, 2008.

(51) Int. Cl. H04W 4/02

(52) U.S. Cl. 370/338

(57) ABSTRACT

A system and method for location determination based on available information about the premises served by a Wireless Access Point is disclosed. More specifically, what is described is a method that enables the mobile terminal to deliver adequate and valuable location information to the service when proper function of the service requires this information.

### CROSS-REFERENCE TO RELATED APPLICATION

The present application claims the benefit of previously filed co-pending Provisional Patent Application, Ser. No. 61/199,477.

### FIELD OF INVENTION

This invention relates to a system and method for location determination based on available information about the premises served by a Wireless Access Point. More specifically, what is described is a method that enables the mobile terminal to deliver adequate and valuable location information to the service when proper function of the service requires this information.

### BACKGROUND OF INVENTION

Wireless LANs permeate the enterprise and home environments. This creates opportunities for new classes of mobile terminals, supporting multiple services ranging from voice to multimedia. This also creates difficulties with respect to location of the terminal for emergency services or commercial applications when the wireless LAN operates indoors. Traditional GPS technologies can be used when the terminal is outdoors, however GPS signals do not reach indoors and location information is not available at the terminal. This disclosure proposes a method for automatic location of the terminal, delivering location information with a precision equivalent to the information available in wire-line networks.

The following disclosure will describe a method that enables the mobile terminal to deliver adequate and valuable location information to the service when proper function of the service requires this information.

### BRIEF SUMMARY OF THE INVENTION

An invention is disclosed that enables the mobile terminal to deliver adequate and valuable location information to the service when proper function of the service requires this information.

It is therefore an object of the invention to supply location services for emergencies and commercial services to users of wireless LANs and devices.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a diagram showing a typical network model;

FIG. 2 is a diagram showing a pairing procedure;

FIG. 3 is a diagram showing an improved pairing procedure;

FIG. 4 is a diagram showing a mobile terminal with pairing and address information; and,

FIG. 5 is a diagram showing a network access with location information.

### DESCRIPTION OF PREFERRED EMBODIMENT

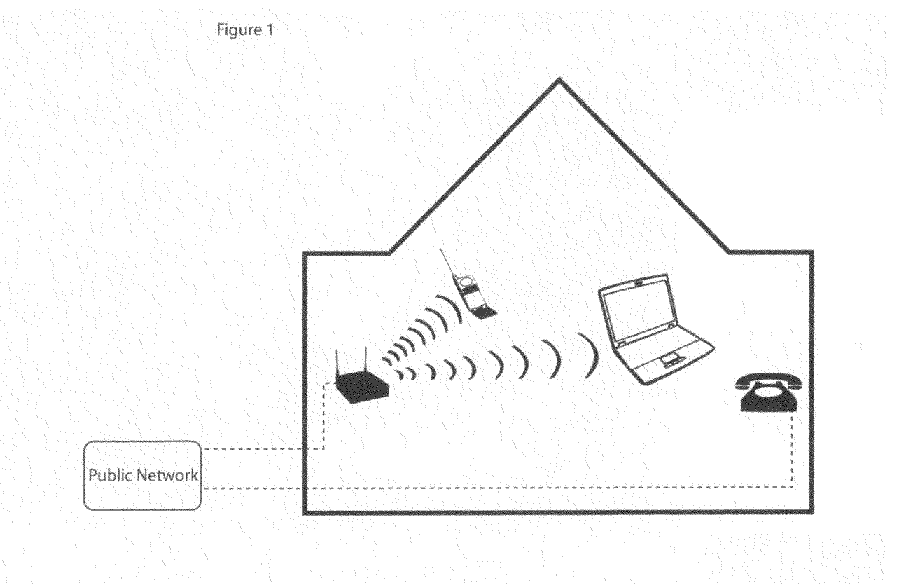

Consider a wireless terminal and an access point as shown in FIG. 1. A Wireless Access Point (WAP) on the left connects the wireless residential enterprise network to the public network outside of the home or business. Wireless terminals roam around the premise, within the range of the WAP. Typical ranges vary by technology and installation, from single meters covering a single room, to a several tens of meters covering the whole premise. The mobile terminal and the WAP use an address to identify and communicate to each other; the address is sometime logical (i.e. the SSID of a Wi-Fi LAN) or physical (i.e. the MAC address of a Wi-Fi or Bluetooth Access Point). The fixed terminal on the right connects directly to the public network. All 3 devices have the same physical address for location services. The physical address can be of the form “street and number, city/state and country” or longitude and latitude coordinates (and optionally height).

Location services are used for several applications, ranging from routing calls to a Public Safety Answering Point (PSAP) covering the location of the caller and dispatching emergency services, to a range of commercial services, present and future. Wired communication devices generally do not provide their location information, and the responsibility to do so is with the network provider using a database of phone numbers and addresses. Difficulties arise with wireless devices because of their ability to roam around, possibly changing location several times during a day. Traditional network information such as phone numbers or IP address are not useful in this case as the fixed phone number does not change when the mobile terminal moves, and pool of IP addresses are generally assigned over a wide geographical area, too large to be of value for location services.

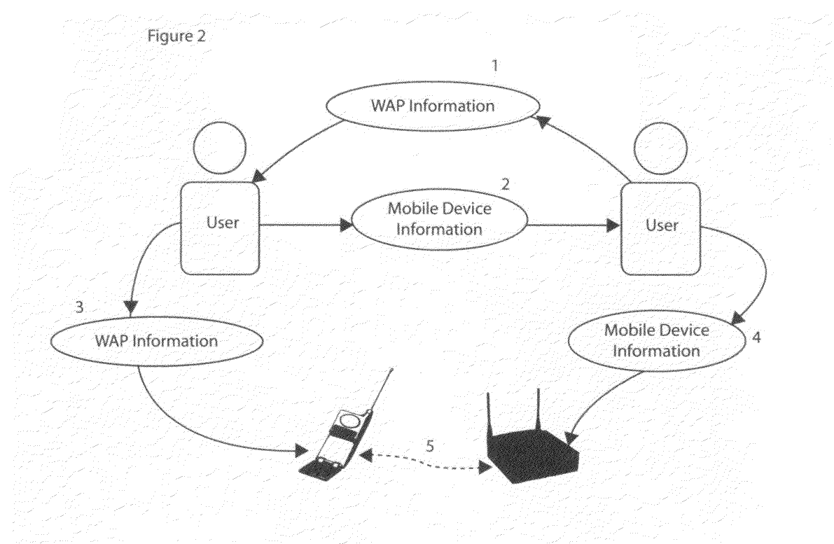

For security, safety, and sometimes for commercial reasons, a mobile terminal attaches to a WAP after the user of the terminal and the operator of the WAP agree and perform a network pairing procedure (in some cases, the owner of the WAP and the user of the mobile terminal are the same, but not always). The pairing procedure can be generalized as the entry of information in the mobile terminal, and sometime in the WAP, allowing the two devices to recognize each over, and often exchange information to secure the communication channel between the two as described in FIG. 2.

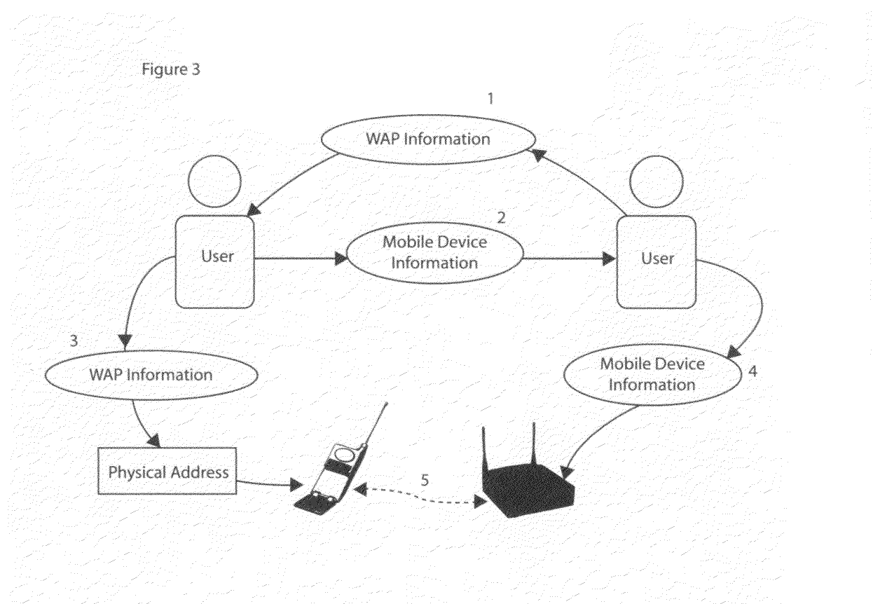

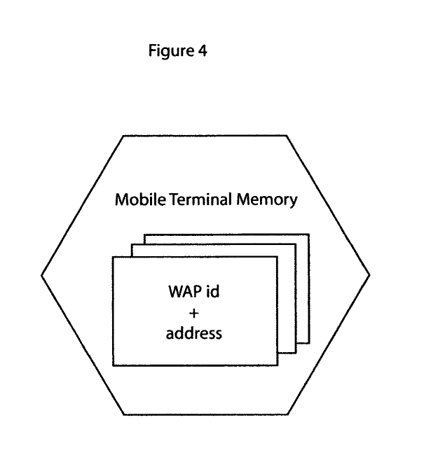

It is disclosed herein that the user of the terminal would also enter the physical address of the premises during the pairing procedure as shown in step 3 of FIG. 3, resulting in pairs of WAP IDs and address information corresponding to the physical address of the premises where the WAP is located, now stored in the memory of the mobile terminal as shown on FIG. 4.

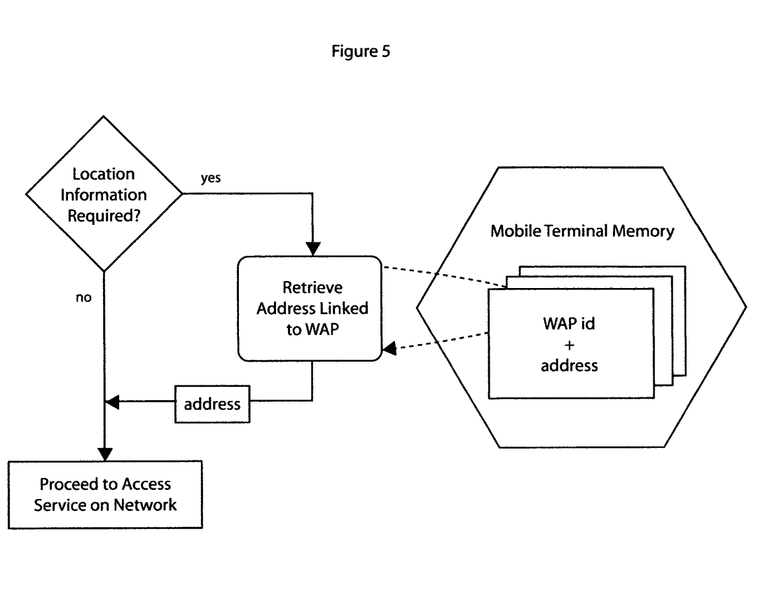

The process that the mobile terminal follows when accessing a service on the network requiring location information is described in FIG. 5. The mobile terminal recognizes that location information is required when accessing a service, and the terminal then proceeds to retrieve the address information linked to the WAP servicing the premises and relays this information to the network during the normal network access procedure. This procedure can be entirely automated and requires no support by the user of the terminal while using the service. The address information retrieved corresponds to the address of the premises covered by the WAP, and since all WAPs have unique identifiers, then the location information retrieved by the terminal corresponds uniquely to the address of the premises.

Thus this application presents a method of providing location services based on available information about the premises served by a Wireless Access Point. This system and method enables the mobile terminal to deliver adequate and valuable location information to the service when proper functioning of the service requires this information.

Since certain changes may be made in the above described location determination services system and method without departing from the scope of the invention herein involved, it is intended that all matter contained in the description thereof, or shown in any accompanying figures shall be interpreted as illustrative and not in a limiting sense.

What is claimed is:

1. A method to supply location information for emergencies and commercial services to users of wireless local area networks comprising:
A mobile wireless terminal;
a wireless access point;
a public network;
said wireless access point in wireless electrical communication with said mobile wireless terminal and also in electrical communication with said public network;
said wireless access point and said mobile wireless terminal creating connection address information that is stored in said mobile wireless terminal memory and said wireless access point memory by undertaking a pairing procedure used for identification and communication between said wireless access point and said mobile wireless terminal;
wherein said pairing procedure also includes storing physical address information regarding the physical location of said wireless access point in said mobile wireless terminal memory and said wireless access point memory; and, wherein when physical location information is required for emergencies and commercial services by a user of said mobile wireless terminal said mobile wireless terminal retrieves said physical location information from said mobile wireless terminal memory and transmits said physical location information to said public network.
